(19) United States
(12) Patent Application Publication
(10) Pub. No.: US 2007/0192022 A1
(43) Pub. Date: Aug. 16, 2007

(54) Method for selecting a location

(76) Inventors: Stefan Lueer, Hildesheim (DE); Thomas Kleine-Besten, Braunschweig (DE); Andreas Jungk, Esslingen (DE)

Correspondence Address: KENYON & KENYON LLP, ONE BROADWAY, NEW YORK, NY, 10004, US

(21) Appl. No.: 11/646,648

(22) Filed: Dec. 27, 2006

(30) Foreign Application Priority Data
Dec. 27, 2005 (DE) 102005062465.0

(51) Int. Cl. G01C 21/00

(52) U.S. Cl. 701/200; 701/201

(57) ABSTRACT

A method for selecting a location. At least two lists of locations are depicted in a display, the beginning of the names of the locations in both lists being in agreement with the same previously entered character string and the basic set from which the entries of the lists are determined being different.

### BACKGROUND INFORMATION

A method and a device for selecting travel destinations in a navigation system are described in European Patent Application No. EP 790 593. Two lists from which a user is able to select a destination are shown in a display for this purpose. The second list contains destinations that have previously been selected from the first list. Thus, a user is able to either select a destination previously driven to from the second list or make an alphabetic entry in order to select a destination from the totality of destinations in the first list.

### SUMMARY OF THE INVENTION

The method according to the present invention for entering a location and the device according to the present invention for processing location information have the advantage that two lists, the entries of which are stored from different basic sets, are depicted in one display, it being necessary, however, for the beginning of the name of displayed list entries to be in agreement with a previously entered character string in both lists. The alphabetic input makes it possible to enter a character string and make a selection from various numbers of locations, thus accordingly simplifying the input. As a result, a character string may be entered not only for a search in one list but also for a search in at least two lists simultaneously.

It is particularly advantageous that the basic set of locations from which the entries in the second list are determined is a subset of the basic set of locations in the first list. A suitable advance selection of the locations in the second list makes it possible to reduce the input time for a location which the user is very likely to select due to the smaller basic set of locations in the second list. At the same time, it is possible to select a location which is not a member of this subset without additional effort compared to a direct selection from only one list.

Furthermore, it is advantageous to select the basic set of entries of at least one list as a function of one characteristic of the particular location or of an earlier input by a user. Thus one of the lists preferably has entries that a user is very likely to select. In particular in the case that it is highly probable that these locations will form a subset of the totality of selectable locations, it is possible to significantly increase the input speed because it is highly probable that the user will find the desired location on the shorter list.

Furthermore, it is advantageous to show locations in the first and in the second list in alphabetical order to facilitate the orientation of the user. In another specific embodiment it is possible to show locations in alphabetical order in the first list, and to choose locations in the second list as a function of a characteristic or of an input previously made by a user. Thus, for example, it is possible to show the first list alphabetically for the selection of a place name from a totality and the second list ranked according to the selection probability of the destinations.

It is further advantageous to show the first and the second list simultaneously in the display. As a result, a user is able to see the consequence of entering another character and how the selection of offered list entries will change as a result.

It is further advantageous that the first and the second list are independently scrollable. In this case, scrollability should be understood to mean that in the event that the entire list or the entries still remaining after input of a character string is not completely depictable in the display, a user may display those entries via a control element input. A user is thus able to check, for example, if a list entry is present, for example, in the short, second list, or if this entry must be selected from the more comprehensive first list, even if this entry is not directly displayed due to the length of the second list.

Furthermore, it is advantageous to show the user the previously entered character string separately. This enables the user to identify the selection that has been made and if this selection needs to be corrected.

Furthermore, it is advantageous to increase the size of the depiction of the displayed lists in a further selection of one of the lists so that the number of displayed entries is enlarged. This makes improved selection of the individual list elements possible. It is thus possible, for example, through a user selection to switch from a simultaneous depiction of two lists to a depiction of only one of the two lists, the area available for the selected list in the display being enlarged.

Furthermore, it is advantageous that after a location is selected, an input window is displayed in order to display or to input additional information about this location. For example, if a city name is selected, it is also possible to enter a street name in the additional input window. Furthermore, in the event that a city name is ambiguous because a plurality of locations have an identical designation, unambiguous selection of the location is offered in the input window.

It is further advantageous to preferably display a first location from the second list for direct selection. The locations in the second list are, for example, preferably selected in such a way that they have a high probability of selection. Preferably a location is then selected that has a high probability of selection in particular. The fact that the user is able to select these locations directly thus makes it possible to avoid an additional list selection.

It is advantageous in particular to use a method according to the present invention in a motor vehicle for inputting a travel destination into a navigation device. In the case of use in a motor vehicle, the user normally does not have a regular keyboard available, making it necessary to make a selection using simple control elements. An advantageous design of the method of the present invention makes it possible to speed up the input of a location into the navigation device as a travel destination.

### BRIEF DESCRIPTION OF THE DRAWINGS

FIG. 1 shows a device according to the present invention for processing location information in the form of a navigation system in a motor vehicle.

FIG. 2 shows a screen display for elucidating the method according to the present invention for selecting a location.

### DETAILED DESCRIPTION

The method of the present invention for selecting a location may be used for selecting any location desired. It is thus possible, for example, to enter a desired location into a conventional computer or even into a small computer, a PDA (personal digital assistant), in a corresponding manner. It is advantageous in particular to use the method of the present invention for selecting a location for entering a travel destination into a navigation device in a motor vehicle. For that reason, the method of the present invention is explained below based on the example of a use for a navigation device.

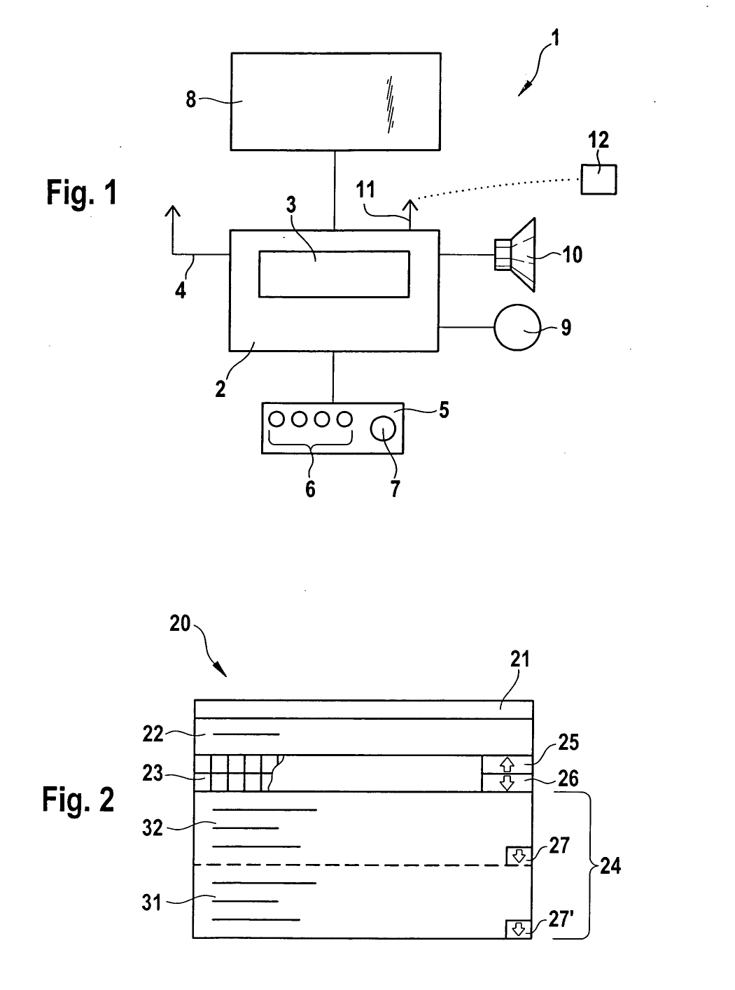

A navigation device 1 in a motor vehicle is shown in FIG. 1. A central processing unit 2 includes a computational unit 3, which performs a route calculation. A position of navigation device 1 is determined using a tracking unit 4, for example a satellite tracking unit. In another specific embodiment, it is also possible to select a starting position via an input. Using a control unit 5 having pushbuttons 6 and/or rotating elements 7, a user selects a travel destination from a selection which is offered on a display 8. The locations that the driver may select as a travel destination are preferably stored in a memory 9. After the travel destination is entered, processing unit 3 calculates a route to the input travel destination by accessing a digital map which is preferably also stored in memory 9. Travel directions may be output to the driver of the vehicle optically via display 8 and/or acoustically via a speaker 10. In another specific embodiment, it is also possible to establish a data connection to a computer 12 outside of the vehicle via a radio interface 11. Computer 12 may accept the route calculation and return a route to the vehicle and navigation device 1. It is also possible for the input of the travel destination that computer 12 previously provided navigation device 1 with a list of possible locations for the selection of a travel destination.

In FIG. 2, an example of a visual depiction 20 is shown in display 8. Visual depiction 20 is used in this case to select a travel destination. In an instruction field 21, operating instructions are output to the user, e.g., to input a travel destination. In an input field 22, the input of a character string previously entered by a user is displayed. In this connection, a character string may be made up of one or more letters. Special characters such as hyphens or numbers, if necessary, should also be understood to be letters in this connection. In a preferred specific embodiment, not only the previously entered character string is displayed in input field 22 but also this character string including additional characters so that a suggested travel destination is offered in input field 22. By making a direct selection via control unit 5, the user is able to select the travel destination displayed in input field 22.

In a character field 23, which is shown in simplified form, a large number of letters is displayed to the user. Via control unit 5, the user is able to select one of these letters as a next character. This character is added to the previously entered character string. If the user has not previously entered a character, the first character of the character string may be selected via character field 23.

In a display area 24, a first list 31 is displayed and a second list 32 is displayed above the first list. In lists 31, 32, the names of locations are depicted, the beginning of which must match the character string previously input by the user. In the embodiment shown here as an example, three list entries each of first and second list 31, 32 are shown in display 8.

In the event that a user has already input at least one first letter of a character string, the following selections are possible: The user may enter an additional letter of the character string and accordingly reduce the number of place names selectable from the two lists 31, 32, or the user may select one of the two lists. In the latter case, all depictions in the display are erased except for instruction field 21 and the particular selected list is displayed instead. Instead of only three entries, it is now possible to show as many as ten entries of the list in display 8. In this case, it is also possible for the list to contain more entries than those depicted, so that the totality of locations matching the previously input character string exceeds the number of simultaneously depictable list elements. In this case, it is preferably possible to use rotating element 7 to scroll the list so that, for example, a rotation of rotating element 7 to the left moves the list down and a rotation of rotating element 7 to the right moves the list up and the following or preceding entry is made visible.

A first input field 25 is used to select second list 32 for an overall depiction. The selection of a second input field 26 is used to select first list 31 for an overall depiction. A symbol 27, 27′ makes it possible to indicate that additional list entries follow. An observer thus knows that the three displayed locations do not represent the entire list content.

If a user chooses one of the entries of the particular selected list and makes a corresponding selection, an additional input window appears instead of the list in which the user may make additional inputs. If the selected location is, for example, the name of a city or a municipality, the user may enter a street name or a house number in a subsequent input step, possibly using the same procedure as when selecting the city or municipality. Upon the selection of an additional selection field, the option may also be offered to start route guidance and thus initiate route calculation by navigation device 1.

In another specific embodiment, it is possible for a user to be able to switch the depiction according to FIG. 2 directly to the depiction of lists 31, 32, for example, by a rotation of rotating element 7 and to select a location depicted there. Furthermore, it is also possible for the user to switch first to one of the two lists 31, 32, to scroll through the lists independently of one another, and thus to search the lists independently of one another.

Preferably, a totality of selectable locations, which forms the basic set of locations of the first list, is stored in memory 9 or in external computer 12. Preferably a location coordinate that may be used for the route calculation is stored for each location. In the embodiment shown here, the first list is used as an alphabetically ordered list of all selectable locations which is also preferably displayed in an alphabetically sorted manner. For a location from the basic set in the first list to be depicted, in addition to the fact that an entry is contained in the basic set, a beginning of a particular place name must be in agreement with the previously entered character string. The number of still selectable and accordingly depictable locations of the first list changes after the character input, i.e., it generally becomes dynamically smaller, corresponding to additional input characters of the character string. This means that the selectable and accordingly depictable locations in the first list are a subset of the basic set of the first list, the input of the character string determining the subset and accordingly the list entries, i.e., the locations to be depicted in first list 31 of display 8. In this case, not all locations in first list 31 to be depicted may be depicted simultaneously in display 8.

In a preferred specific embodiment, the second list as a basic set assumes a subset of the totality of selectable locations, which irrespective of a character input is already limited compared to the basic set of the first list before the character input and thus forms a subset of the basic set of the first list. The locations that are members of this subset are preferably stored in memory 9. Corresponding locations may be stored in a list or an assignment to the individual locations may also be stored.

Preferably only those locations that have a high probability of being selected by the user are selected for the basic set of locations of the second list. This higher probability may be determined according to various criteria. For the depiction in the display, the locations of the basic set of second list 32 must also always agree with the previously input character string.

For the basic set of the second list, from which the locations of second list 32 to be depicted are determined by considering the input character string, it is possible to consider the last travel destinations input by the user, e.g., the last ten destinations. As an alternative or in addition, characteristics of the locations may be considered. Thus cities above a specified population, for example, cities having a population greater than 50,000, may be included in the basic set of the second list. It is also possible, for example, in a data record including Germany and Europe, to only include locations in Germany in the basic set of the second list. Furthermore, special locations, in particular locations of special relevance to tourism, may be included in the basic set of the second list. It is also possible for a user to manually include a location in the basic set of the second list by making a corresponding selection even if this location was not selected previously and there is no other reference to this location. With regard to a selection of streets that may also be seen as locations, the length of the street may be taken into consideration as a characteristic in such a manner that only streets above a predetermined length or only the longest street having this name is included in the basic set of the second list.

It is also possible to consider the present position of the vehicle for forming the basic set of the second list. Accordingly, dynamic, location-dependent or, if necessary, also time-dependent formation of the basic set of the second list is possible. It is thus possible to include, for example, locations within a radius of 20 km of the vehicle position in the second list. In another specific embodiment, it is also possible in the case of locations having the same name or at least very similar ones, to include the location having the smaller distance to the present location in the basic set. It is also possible to count how often the vehicle has already traveled to a destination. Travel destinations that have been traveled to more than ten times, for example, are also included in the basic set of second list 32. Furthermore, it is also possible for locations to be deleted from the basic set of the second list. For example, it is possible for locations that have been stored as the last destinations or were traveled to very often to be erased from the list, for example, if they have not been traveled to again in the meantime.

The depiction of the second list is based on a subset of the basic set of the second list, the subset of the second list being determined by the same previously input character string, with which the initial letters of the names of the first list must also agree. The locations of second list 32 may also be displayed in an alphabetically sorted manner just like the locations in first list 31. In another embodiment, it is also possible to display the locations in second list 32 by considering the previously input character string ordered according to the distance from the present position of the vehicle.

The selection of one of the two lists 31, 32 is preferably made by the user. In the event that one location of the last ten destinations is contained in second list 32 and that the first three characters, for example, already agree with this location, a switch is automatically made to the overall depiction of second list 32 in a preferred embodiment. If another location is desired, it is possible to automatically reset this selection.

In the exemplary embodiment described thus far, the basic set of locations depicted in second list 32 represents a subset of the basic set of first list 31. In another embodiment, it is also possible for the two basic sets to be disjunctive. As a result, travel destinations of a first category, for example, restaurant names, may be listed in first list 31, for example, while locations of another category, for example, museums, are listed in second list 32. It is also the case here that the displayed entries must always agree with the previously input character string.

A text example of an input method according to the present invention is explained in the following. In this example, a user has selected the letter “D” as the first letter of the character string. The instruction “Please enter city” appears in instruction field 21. The place name “Dortmund” appears in this input field. The second letter, “O” is highlighted by a cursor. This makes it clear that this place is occupied by the next input from character field 23.

Dortmund is the city with the highest population having initial letter D. For that reason, Dortmund is selected for input field 22.

The following place names now appear one above the other in the depiction of second list 32:

DORTMUND;

DREIEICH;

DRESDEN.

The first entries appear in the depiction of the first list:

D'HORN;

D.EIS, ALBSHEIM A.;

D.EIS, MÜHLHEIM A. situated one above the other.

Due to the special characters in the second position, these locations are listed at the front of the alphabet. The location “DREIEICH” appears between Dortmund and Dresden because the driver recently traveled there. In the present case, the location limit for inclusion in a second list is set at 200,000 inhabitants so that Darmstadt, for example, does not appear in the first list although it is ahead of Dortmund in the alphabet.

In the following, the user enters “R” as the second letter of the character string. In the depiction of the first list, the entry changes to the locations:

DRABENDERHÖHE;

DRABEL;

DRACHENBERG.

In the depiction of the second list, the location entry changes to the two locations:

DREIEICH;

DRESDEN.

Input field 22 now shows the place name “DREIEICH.” The user may either select the location Dreieich directly or select one of the two lists via input fields 25, 26 or enter another letter. In the event that the user selects the first list via second input field 26, the depiction changes in display 8. The instruction “Please choose entry” is shown in instruction field 21. Under it the following locations appear: “DRABENDERHÖHE, DRABEL, DRACHENBERG, DRACHHAUSEN, DRACKENSTEDT, DRAHNSDORF, DRAKENBURG, DRANGSTEDT, DRANSE, DRANSFELD.” The user is now able, for example, to select one of these locations via rotating element 7. If, for example, the user selects DRABEL, an input mask which is labeled with the instruction “Destination input” in instruction field 21 appears instead of the list. In this connection, the country, Germany in this case, in which the city of Drabel is located, is displayed once more to the user. Via an input field, the user is now able to enter the street and house number of the intended destination in Drabel. Another field permits the user to start route guidance via this selection.

If the user has instead chosen the second list, the remaining entries of the second list are displayed and now only include the two locations Dreieich and Dresden. In the same manner, the user is now able to select one of these locations for a more exact destination input or to select the start of route guidance to one of the locations.

What is claimed is:

1. A method for selecting a location, comprising:
depicting a first list and a second list of locations for selecting the location from one of the lists in a display for the selection of locations, particular basic sets of the locations from which entries of the lists are determined being different, a beginning of names of the locations in both depicted lists agreeing with a same previously entered character string.

2. The method according to claim 1, wherein the basic set of locations from which the entries in the second list are determined is a subset of the basic set of locations from which the entries in the first list are determined.

3. The method according to claim 1, wherein the basic set of locations of at least one of the lists is determined as a function of a characteristic of at least one of a particular location and an input made by a user.

4. The method according to claim 1, wherein locations are depicted in alphabetical order in the first and second lists.

5. The method according to claim 1, wherein the locations in the first list are depicted in alphabetical order and the locations in the second list are depicted in a sequence as a function of at least one of a characteristic of particular locations and an input previously made by a user.

6. The method according to claim 1, wherein the first and the second lists are depicted simultaneously in the display.

7. The method according to claim 1, wherein the first and the second lists are scrollable independently of one another.

8. The method according to claim 1, wherein the previously entered character string is depicted separately.

9. The method according to claim 1, wherein for another selection of a location, one of the lists can be selected in such a way that a number of depicted entries of a selected list is enlarged.

10. The method according to claim 1, wherein after a location is selected, an input window is displayed for an input of at least one of additional information and commands concerning the location.

11. The method according to claim 1, wherein a first location from the second list is displayed for direct selection.

12. The method according to claim 1, wherein the method is used for entering a travel destination into a navigation device, in a motor vehicle.

13. A device for processing location information comprising:
a display for depicting selectable locations;
control elements for entering a character string and for selecting a location shown in the display;
a memory for storing a multitude of locations; and
a processing unit for displaying at least two lists in the display, basic sets of locations from which entries of the lists are determined in each case being different,
wherein at least a beginning of names of the locations in both lists agrees with a same previously entered character string.
